(19) United States
(12) Patent Application Publication
(10) Pub. No.: US 2026/0208569 A1
(43) Pub. Date: Jul. 23, 2026

(54) MULTI-PIECE ROOF FOR AN AUTOMOTIVE CANOPY

(71) Applicant: RSI North America, Inc., Fort Worth, TX (US)

(72) Inventors: Michael VOSS, Fort Worth, TX (US); Jozua JOUBERT, Fort Worth, TX (US); Marius Dreyer, Fort Worth, TX (US)

(21) Appl. No.: 19/029,088

(22) Filed: Jan. 17, 2025

(51) Int. Cl. B60J 7/16; B60H 1/26; B65D 85/68; B65D 90/02

(52) U.S. Cl. CPC B60J 7/1607; B60H 1/262; B65D 85/68; B65D 90/027

(57) ABSTRACT

A multi-piece roof includes a left extension panel, a right extension panel, and a central roof panel. The left extension panel has a proximal end with a first width and a distal end with a second width. The right extension panel has a proximal end with a third width and a distal end with a fourth width. The central roof panel has a top side, a bottom side, a left side, a right side, a front side and a back side. The left side is configured to couple with the left extension panel and the right side is configured to couple with the right extension panel and the right extension panel.

### BACKGROUND

The present disclosure generally relates to a multi-piece roof for an automotive canopy. Typically, a vehicle bed comprises a generally flat surface located behind a vehicle cabin and may typically have sidewalls and a rear tailgate. The vehicle bed may be used for a number of utility purposes, including transporting cargo. Further, a vehicle bed may include a canopy, or cap, or rack system creating an enclosure on the vehicle bed. The vehicle canopy, cap or rack system may protect cargo from the elements and prevent cargo from falling off or out of the vehicle bed when the vehicle is moving. Additionally, a vehicle canopy could be useful for providing a compartment for sleeping during overlanding, which consists of overland travel to remote destinations.

### SUMMARY

The present disclosure provides new and innovative systems, methods and apparatus for a multi-piece roof for an automotive canopy. In an example, a multi-piece roof for an automotive canopy includes a left extension panel, a right extension panel, and a central roof panel.

In a first aspect of the present disclosure, the multi-piece roof includes a left extension panel, a right extension panel, and a central roof panel. The left extension panel has a proximal end with a first width and a distal end with a second width. The right extension panel has a proximal end with a third width and a distal end with a fourth width. The central roof panel has a top side, a bottom side, a left side, a right side, a front side and a back side. The left side is configured to couple with the left extension panel and the right side is configured to couple with the right extension panel and the right extension panel.

In light of the disclosure herein and without limiting the disclosure in any way, in an aspect of the present disclosure, which may be combined with any other aspect listed herein unless specified otherwise, the left extension panel, the right extension panel, and the central roof panel are sized and shaped to fit within a single shipping container.

In accordance with a second aspect of the present disclosure, which may be used in combination with any other aspect listed herein unless stated otherwise, the left extension panel is configured to connect to a left-side panel, a front panel, and a rear panel of the automotive canopy.

In accordance with a second aspect of the present disclosure, which may be used in combination with any other aspect listed herein unless stated otherwise, the right extension panel is configured to connect to a right-side panel, the front panel, and the rear panel of the automotive canopy.

In accordance with a second aspect of the present disclosure, which may be used in combination with any other aspect listed herein unless stated otherwise, the central roof panel is configured to connect to the front panel and the rear panel of the automotive canopy.

In accordance with a second aspect of the present disclosure, which may be used in combination with any other aspect listed herein unless stated otherwise, the left extension panel, the right extension panel, the central roof panel, the left-side panel, the right-side panel, the front panel, and the rear panel are sized and shaped to fit within a single shipping container.

In accordance with a second aspect of the present disclosure, which may be used in combination with any other aspect listed herein unless stated otherwise, the shipping container is made at least partially from cardboard.

In accordance with a second aspect of the present disclosure, which may be used in combination with any other aspect listed herein unless stated otherwise, the shipping container is a corrugated cardboard box.

In accordance with a second aspect of the present disclosure, which may be used in combination with any other aspect listed herein unless stated otherwise, the left extension panel, the right extension panel, and the central roof panel are configured to attach to and fit onto a first model type of pickup truck.

In accordance with a second aspect of the present disclosure, which may be used in combination with any other aspect listed herein unless stated otherwise, the central roof panel and a set of different extension panels are configured to attach to and fit onto a second model type of pickup truck where the second model type of pickup truck is different from the first type of pickup truck and has different truck bed dimensions that the first model type of pickup truck.

In accordance with a second aspect of the present disclosure, which may be used in combination with any other aspect listed herein unless stated otherwise, the first width and the second width of the left extension panel depend on a model type of pickup truck that the vehicle canopy is adapted for.

In accordance with a second aspect of the present disclosure, which may be used in combination with any other aspect listed herein unless stated otherwise, the central roof panel has a length and width, the length of the central roof panel is a first length and the width is a first width for a first model type of vehicle.

In accordance with a second aspect of the present disclosure, which may be used in combination with any other aspect listed herein unless stated otherwise, the length is a second length and the width is the first width for a second model type of vehicle, the second model type being different than the first model type.

In accordance with a second aspect of the present disclosure, which may be used in combination with any other aspect listed herein unless stated otherwise, the multi-piece roof further includes a removable vent insert. The central roof panel includes a vent aperture adapted to receive the removable vent insert.

In accordance with a second aspect of the present disclosure, which may be used in combination with any other aspect listed herein unless stated otherwise, the multi-piece roof further includes a plurality of support braces that are sized and shaped to span across the central roof panel. The vent aperture is spaced between two of the plurality of support braces.

In accordance with a second aspect of the present disclosure, which may be used in combination with any other aspect listed herein unless stated otherwise, the plurality of support braces are formed by stamping and folding metallic material.

In accordance with a second aspect of the present disclosure, which may be used in combination with any other aspect listed herein unless stated otherwise, a modular kit for assembly of a multi-piece roof for an automotive canopy includes a left extension panel, a right extension panel, a central roof panel, and a plurality of support braces. The central roof panel has a left side, a right side, a top side and a bottom side. The left side is configured to couple with the left extension panel and the right side is configured to couple with the right extension panel. The plurality of support braces is configured to couple to the bottom side of the central roof panel.

In accordance with a second aspect of the present disclosure, which may be used in combination with any other aspect listed herein unless stated otherwise, the modular kit further includes an air vent located on the central roof panel.

In accordance with a third aspect of the present disclosure, which may be used in combination with any other aspect listed herein unless stated otherwise, an automotive canopy includes a front panel, a plurality of side panels, a rear panel, and a multi-piece roof. The multi-piece roof includes a left extension panel, a right extension panel, a central roof panel, and a plurality of support braces. The central panel has a left side, a right side, a top side and a bottom side. The left side is configured to couple with the left extension panel and the right side is configured to couple with the right extension panel. The plurality of support braces is configured to couple to the bottom side of the central roof panel.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE FIGURES

FIG. 1 illustrates a perspective view of an automotive canopy for use with an automobile, according to various examples of the present disclosure.

FIG. 2A illustrates a perspective view of a multi-piece roof panel of an automotive canopy, according to various examples of the present disclosure.

FIG. 2B illustrates a bottom plan view of the multi-piece roof panel of FIG. 2A, according to various examples of the present disclosure.

FIG. 2C illustrates a top plan view of the multi-piece roof panel of FIG. 2A, according to various examples of the present disclosure.

FIG. 2D illustrates a rear view of the multi-piece roof panel of FIG. 2A, according to various examples of the present disclosure.

FIG. 3A illustrates a perspective view of a central roof panel of a multi-piece roof panel, according to various examples of the present disclosure.

FIG. 3B illustrates a perspective view of the central roof panel of FIG. 3A, according to various examples of the present disclosure.

FIG. 3C illustrates a bottom view of the central roof panel of FIG. 3A, according to various examples of the present disclosure.

FIG. 3D is an enlarged partial view of an attachment interface, according to various examples of the present disclosure.

FIG. 3E is an enlarged partial view of an engagement interface, according to various examples of the present disclosure.

FIG. 4A illustrates a perspective view of an extension panel, according to various examples of the present disclosure.

FIG. 4B illustrates another perspective view of the extension panel of FIG. 4A, according to various examples of the present disclosure.

FIG. 4C illustrates a cross-sectional view of the extension panel about line 4C-4C of FIG. 4A, according to various examples of the present disclosure.

FIG. 5A illustrates a perspective view of a lateral support brace, according to various examples of the present disclosure.

FIG. 5B illustrates an enlarged partial view of the lateral support brace of FIG. 5A, according to various examples of the present disclosure.

FIG. 5C illustrates a front view of the lateral support brace of FIG. 5A, according to various examples of the present disclosure.

FIG. 5D illustrates a top view of the lateral support brace of FIG. 5A, according to various examples of the present disclosure.

FIG. 6 illustrates a perspective view of a mounting portion of a side panel, according to various examples of the present disclosure.

FIG. 7A illustrates an exploded perspective view of a side assembly, according to various examples of the present disclosure.

FIG. 7B illustrates a perspective view of the side assembly of FIG. 7A after the mounting portion of a side panel is advanced forward and fully inserted into an extension panel, according to various examples of the present disclosure.

FIG. 7C illustrates a perspective view of the side assembly of FIG. 7A after the mounting portion of a side panel is advanced forward and fully inserted into an extension panel, according to various examples of the present disclosure.

FIG. 7D is an enlarged partial view of an alignment and installation tab interfacing with an alignment and installation slot, according to various examples of the present disclosure.

### DETAILED DESCRIPTION OF EXAMPLE EMBODIMENTS

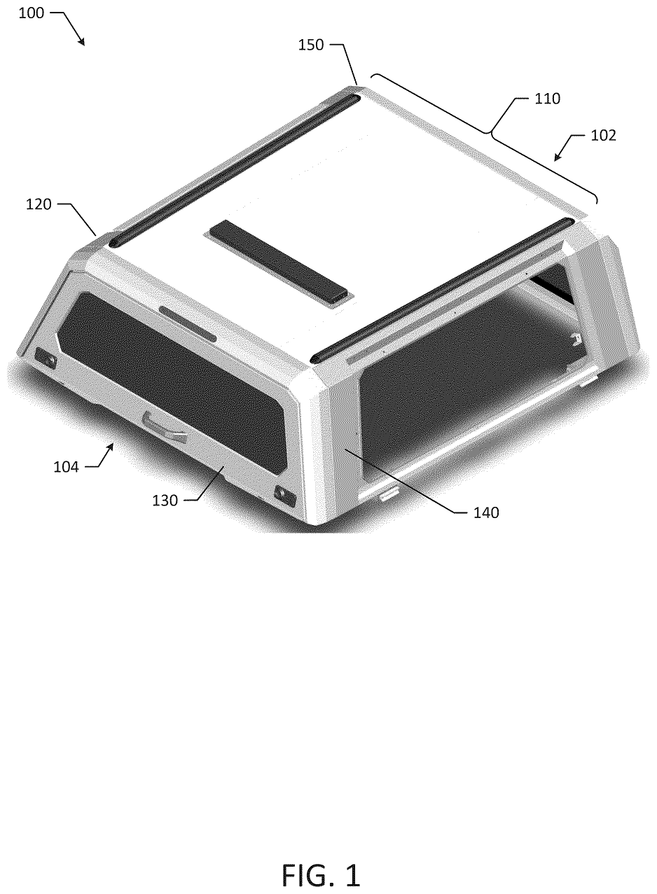

FIG. 1 illustrates a perspective view of an automotive canopy 100 for use with an automobile, such as a truck, according to various examples of the present disclosure. The truck canopy or automotive canopy 100 includes a multi-piece roof panel 110, a left-side panel 120, a rear panel 130, a right-side panel 140, and a front panel 150. The side panel(s) 120 and 140, rear panel 130, and front panel 150 may include windows, doors, latches or other access and visibility features. As illustrated in FIG. 1, the multi-piece roof panel 110 extends from the proximal end 102 to the distal end 104 of the automotive canopy 100. The multi-piece roof panel 110 attaches to the left-side panel 120, right-side panel 140, rear panel 130 and front panel 150 to form the automotive canopy 100.

The automotive canopy 100 illustrated in FIG. 1, or portions of the automotive canopy 100, may be provided as a modular kit for assembly. For example, the components of the automotive canopy 100 may be packaged and shipped for on-site assembly. In an example, each component of the automotive canopy 100 may be shipped in the same shipping container. By providing the roof panel in a multi-piece configuration (e.g., multi-piece roof panel 110), the overall dimensions of the shipping container are reduced since each piece of the multi-piece roof panel 110 is smaller than a single piece roof panel, which advantageously allows for more compact and smaller shipping containers, thereby reducing shipping costs. Typically, the width and length of a single piece roof panel makes shipping difficult, cumbersome and expensive due to the size and shape of an automotive canopy 100 and more specifically the single piece roof, which often increases the “shipping width.” Shipping width may refer to the width of a shipping container, which is often controlled by the dimensions of widest component shipped. Reducing the “shipping width” of the roof panel by providing the panel in a multi-piece configuration advantageously makes the multi-piece roof panel 110 and/or the automotive canopy 100 more shippable and typically reduces shipping costs by allowing fewer and/or smaller shipping containers/packages to be shipped.

Shipping in smaller, more compact containers/packages also reduces the likelihood of damage during shipment. For example, a single piece roof panel may be more susceptible to damage, bending, twisting or other defects during shipping due to its larger size and shape. To prevent or reduce the risk of damage during shipping, components of the automotive canopy, such as a single piece roof panel may require (i) additional protection, (ii) higher grade (e.g., heavy duty) packaging, such as a banded palate, and/or (iii) multiple shipping containers/packages to ensure safe transportation, which increases shipping costs. Furthermore, in the event a portion of the roof panel is damaged during shipping, a multi-piece roof panel 110 may only incur damage to a single component. Therefore, unless each panel of the multi-piece roof panel 110 is damaged, only a portion of the roof needs to be replaced whereas a damaged single panel roof would require a full replacement. Replacing a portion of the roof panel instead of the entire roof panel advantageously reduces replacement costs (e.g., part and material costs, replacement shipping costs, etc.). Further details and advantages of the multi-piece roof panel 110 are described below.

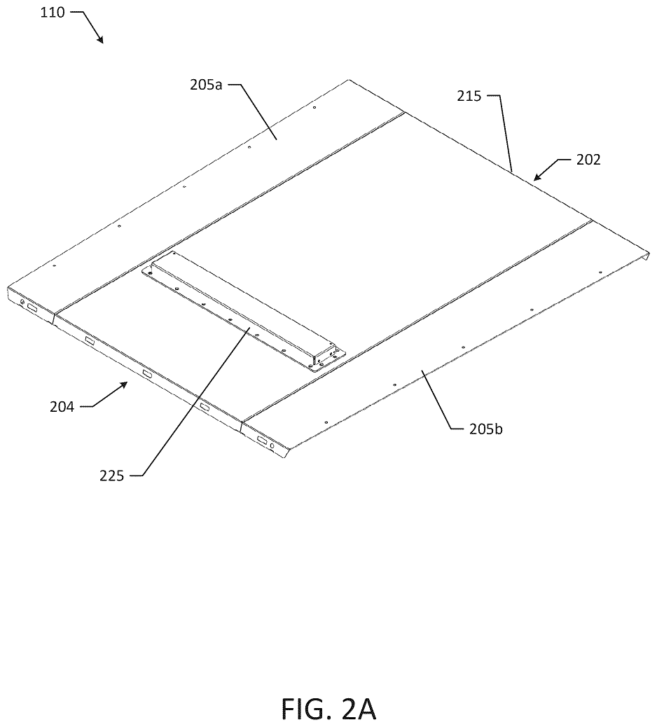

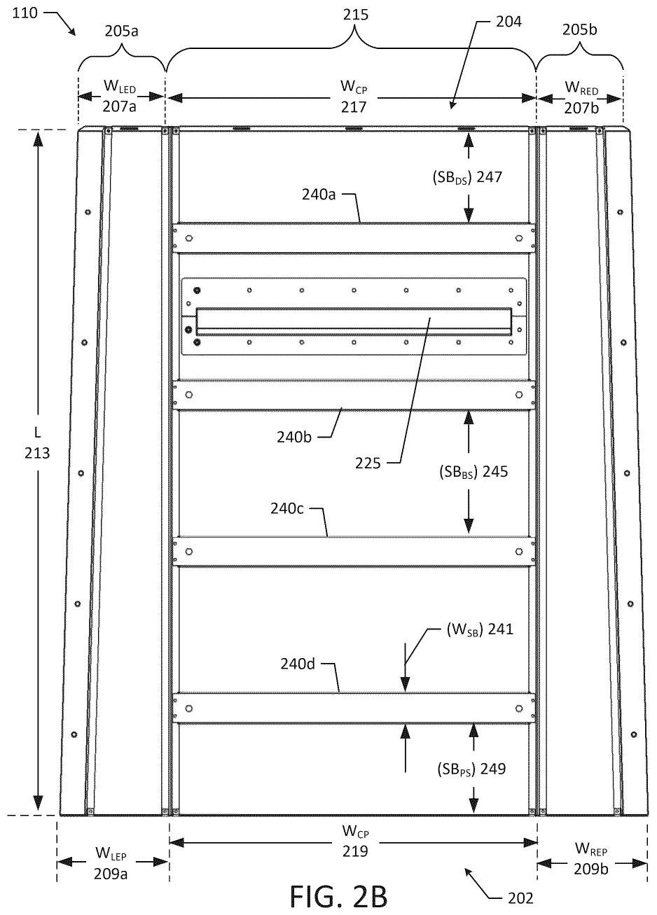

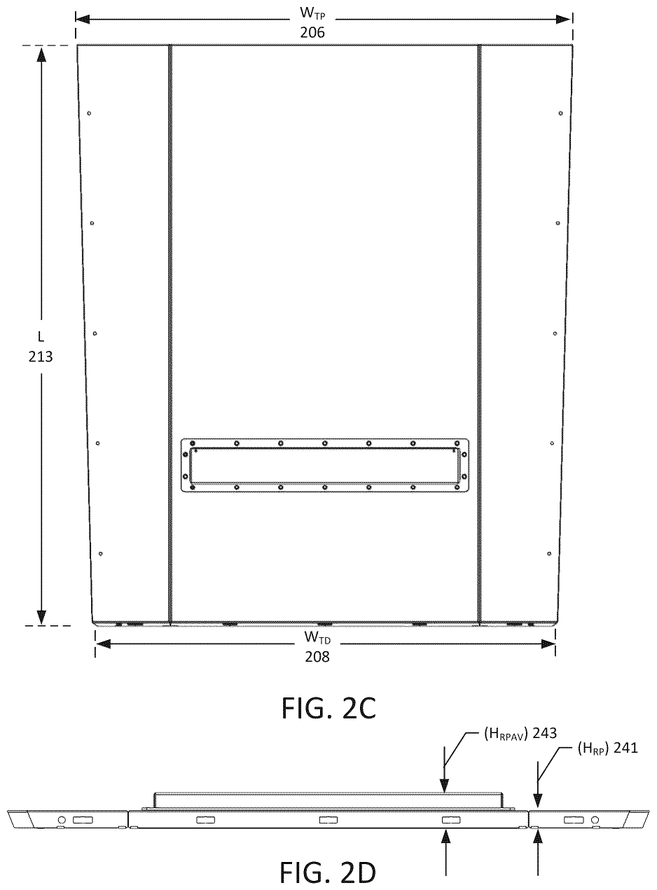

FIG. 2A illustrates a perspective view of the multi-piece roof panel 110, which includes a pair of side extension panels 205 (e.g., left extension panel 205a and right extension panel 205b) and a central roof panel 215. The multi-piece roof panel 110 may also include an air vent 225, such as a positive pressure air vent. In some examples, the air vent 225 may be integrally formed as part of the central roof panel 215. In other examples, the air vent 225 may be a separate component that is adapted to be mounted to, mated with or otherwise coupled to the central roof panel 215.

FIG. 2B illustrates a bottom plan view of the multi-piece roof panel 110. As shown in FIG. 2B, the multi-piece roof panel 110 may be wider at the proximal end 202 than the distal end 204. For example, the total width at the proximal end 202 is the sum or combination of the width (W_{LEP}) 209a of left extension panel 205a, the width (W_{CP}) 219 of the central roof panel 215, and the width (W_{REP}) 209b of right extension panel 205b. Similarly, the total width at the distal end 204 of the multi-piece roof panel 110 is the sum or combination of the width (W_{LED}) 207a of left extension panel 205a, the width (W_{CP}) 217 of the central roof panel 215, and the width (W_{RED}) 207b of right extension panel 205b. As discussed in more detail below, the width of the central roof panel 215 may remain constant between the proximal and distal ends 202, 204 such that the width (W_{CP}) 219 of the central roof panel 215 at the proximal end 202 is equal to the width (W_{CP}) 217 of the central roof panel 215 at the distal end 204. Conversely, as illustrated in FIG. 2B, the width of the extension panels 205 at the proximal end 202 (e.g., W_{LEP} 209a and W_{REP} 209b) is greater than the width of the extension panels 205 at the distal end 204 (e.g., W_{LEP} 209a and W_{REP} 209b).

The difference widths at the proximal end 202, which is near the cab end of a pickup truck and the distal end 204, which is at the tailgate end of a pickup truck, may advantageously allow for a tapered automotive canopy 100 that tapers or narrows when moving from the proximal end 202 to the distal end 204. By having different widths at each end of the multi-piece roof panel 110, the resulting automotive canopy 100 (illustrated in FIG. 1) that includes the multi-piece roof panel 110 may have improved aerodynamic performance compared to automotive canopies that use a non-tapered or rectangular roof, which improves gas mileage for the automobile on which the canopy is installed.

Several components of the multi-piece roof panel 110, which includes a pair of side extension panels 205 (e.g., left extension panel 205a and right extension panel 205b) and a central roof panel 215 may each have the same length (L) 213, such that the side extension panels 205 and the central roof panel 215 may appear to be a single contiguous roof panel once attached to each other. The length (L) 213 of the side extension panels 205 and central roof panel 215 depends on one or more of the vehicle type, bed length, and vehicle manufacturer. For example, some manufacturers may have slightly different bed dimensions even though the truck beds may be marketed as the same size. Even though the length (L) 213 of the components often changes based on the vehicle model or brand, the width (W_{CP}) 217, 219 of the central roof panel 215 is typically the same regardless of the vehicle model or brand. In some examples, a central roof panel may be used for several different vehicle canopy kits for different vehicle models and/or brands. The differences in truck bed widths may be accommodated by adjusting the widths of the side extension panels, thereby reducing the number of different configurations for the central roof panel 215, making the central roof panel 215 semi-universal (e.g., the same sized central roof panel 215 may be used in several different vehicle canopy kits).

In an example, the multi-piece roof panel 110 may include lateral support braces 240 (e.g., support braces 240a-d) extending across or spanning the width of the central roof panel 215. While the illustrated example includes four lateral support braces 240, it should be appreciated that more support braces (e.g., more than four) or less lateral support braces (e.g., less than four) may be used depending on the length of the accompanying truck bed associated with the roof panel. Furthermore, while rectangular lateral support braces are illustrated in FIG. 2B, other types, styles and geometries of support structures may be used to provide support and rigidity to the multi-piece roof panel 110 when installed. The lateral support braces may be spaced from each other, the proximal end 202, and the distal end 204 by predetermined amounts, which may be based at least partially on one or more of the quantity of lateral support braces 240, the overall length (L) 213 of the multi-piece roof panel 110, the position and placement of vent 225, materials of the various components of the multi-piece roof panel, as well as the shape and characteristics of the lateral support braces 240.

The spacing between the lateral support braces (SB_{BS}) 245 may be the same for each of the lateral support braces 240, such that the spacing between lateral support brace 240a and 240b is the same as the spacing (SB_{BS}) 245 from lateral support brace 240b to lateral support brace 240c. Similarly, the spacing between lateral support brace 240c and lateral support brace 240d may also be (SB_{BS}) 245. By maintaining the same spacing between lateral support braces 240, the multi-piece roof panel 110 may have similar and consistent rigidity and structural support along the length of the roof. The spacing from the lateral support brace closest to the proximal end 202 (e.g., lateral support brace 240d) may be spaced from the proximal end 202 by a distance of (SP_{PS}) 249. Similarly, the spacing from the lateral support brace closest to the distal end 204 (e.g., lateral support brace 240a) may be spaced from the distal end 204 by a distance of (SB_{DS}) 247. In the illustrated example, (SB_{PS}) 249 and (SB_{DS}) 247 may be the same distance and may be smaller than the spacing distance (SB_{BS}) 245. The shorter or reduced spacing near the proximal and distal ends 202, 204 may provide extra rigidity near the outside edges of the multi-piece roof panel 110, when joined together.

The air vent 225 may be positioned between two of the support braces 240, such that the support braces 240 may provide additional support and rigidity to account for the material removed for the air vent aperture within the central roof panel 215. In an example, the air vent 225 is positioned evenly within the spacing (e.g., pacing distance (SB_{BS}) 245) between two of the support braces (e.g., support brace 240a and support brace 240b). It should be appreciated that the spacing discussed herein is from an outside edge of a support brace 240 to the closest outside edge of the next support brace 240 and/or proximal and distal ends 202, 204 of the multi-piece roof panel 110. The spacing (SB_{PS}) 249 and (SB_{DS}) 247 may also depend on the width (W_{SB}) 241 of the support braces 240. In an example, the sum of (i) the spacing (SB_{PS}) 249 between the proximal end 202 to the closest outside edge of support brace 240d and (ii) the width (W_{SB}) 241 of the support braces 240 may be equal to the spacing (SB_{BS}) 245 from lateral support brace 240b to lateral support brace 240c (e.g., SB_{PS}+W_{SB}=SB_{BS}).

Moving now to FIG. 2C, which is a top plan view of the multi-piece roof panel 110 and FIG. 2D, which is a rear view of the multi-piece roof panel 110, the multi-piece roof panel 110 has a height (H_{RP}) 241 that is consistent between the pair of side extension panels 205 (e.g., left extension panel 205a and right extension panel 205b) and a central roof panel 215. For example, the height of the left extension panel 205a, the right extension panel 205b and the central roof panel 215 may all have the same height. The height of the multi-piece roof panel 110 may be taller in the central roof panel section 215 if that section includes air vent 225. The height of the multi-piece roof panel 110 and/or the central roof panel 215 with air vent 225 installed may be (H_{RPAV}) 243.

During installation, the central roof panel 215 may be attached to the pair of side extension panels 205 with mounting hardware. For example, each side panel from the pair of side roof panels 205 may be attached to the central roof panel 215. In an example, the mounting hardware may include a fastener, a fastener block and clamp, a lock washer, and a bolt (e.g., M6 bolt). The bolts between the side panels 205 and the central roof panel 215 may be tightened to 4-6 Nm, and preferably 5 Nm or 3.7 ft-lbs. Similar mounting hardware and fastener blocks may be used to connect the front, rear and side panels to form the automotive canopy 100.

By forming the roof with a pair of side extension panels 205 and a central roof panel 215, the multi-piece roof panel 110 may be configured for different types, styles and/or models of automotive vehicles (e.g., different pickup trucks). For example, some automobiles, such as pickup trucks have truck beds with different lengths, widths and dimensions requiring a different combination of side extension panels 205 and central roof panel 215. Specifically, some automotive manufacturers may offer dimensionally different truck beds from other automotive manufacturers. One automotive manufacturer may offer pickup trucks with truck beds that range from 5.5 to 8.0 feet, with selectable bed lengths as 5.5 feet (e.g., 67.1 inch box length), 6.5 feet (78.9 inch box length) or 8.0 feet long (97.6 inch box length) while another automotive manufacturer may offer trucks with bed lengths of 5.0 feet (60.3 inch box length) or 6.0 feet (73.5 inch box length).

In other examples, the truck beds between manufacturers may be the same lengths, but with slightly different widths. For different types, styles and/or models of trucks with truck beds having the same length, but different widths, the same central roof panel 215 may be compatible with two different models of truck by pairing the central roof panel 215 with different sets of extension panels 205. In an example, the width of the central roof panel 215 may be the same for each configuration of the multi-piece roof panel 110, thereby advantageously improving economies of scale for the multi-piece roof panel 110 as one version of central roof panel 215 may be combined with different versions of the extension panels 205 for various multi-piece roof panel kits. Maintaining the central roof panel 215 with a consistent width may also reduce tooling costs, distribution costs, etc.

The maximum width (W_{CP}) 217 and/or (W_{CP}) 219 of the central roof panel 215 may be based on shipping container dimensional constraints. For example, the central roof panel 215 may be sized and shaped such that the central roof panel 215 may be shipped in the same shipping container, such as a box (e.g., cardboard box), as the other components for the automotive canopy 100 illustrated in FIG. 1. It should be appreciated that various types and grades of cardboard may be used for the shipping container. In an example, the shipping container material (e.g., cardboard) is strong enough such that multiple containers may be stacked on top of each other (e.g., a stack of 3 cardboard shipping containers). In an example, the automotive canopy may be shipped in one or more packages or boxes and transported in a standard 40-foot transport container (e.g., 40 feet tall by 8 feet wide by 8.5 feet tall). It should be appreciated that other transport containers may be used.

By providing each of the components for the automotive canopy in a single shipping container (e.g., cardboard box), shipping and tracking is advantageously simplified by reducing the quantity of packages that need to be delivered and tracked. Furthermore, sending the automotive canopy a single shipping container or package (or by minimizing the quantity of packages needed to ship the entire canopy) reduces the likelihood of a single component being delayed, damaged or misplaced during shipping. Furthermore, by having all the components in a single shipping container, there is less likelihood of an installer mixing up or mismatching parts or components of the canopy for different vehicle models. For example, a mechanic or assembly shop may specialize in installing automotive canopies and may have several different canopy models on site, getting delivered or installed at the same time. If each of the automotive canopies came in several shipping containers, the risk of mismatching or misplacing components may increase. However, since all the appropriate components for a specific vehicle model are in the same shipping container (e.g., cardboard box), the risk of mismatching parts is greatly reduced. Further, the shipping of each canopy unit in a single shipping container improves the space efficiency by, for example, 20% (e.g., 54 units per transport container vs. 45 units per transport container). The improved shipping efficiency reduces energy usage, pollution, and costs on a per unit basis.

The multi-piece roof panel 110 illustrated in FIGS. 2A-2D may be provided as a modular kit for assembly. For example, the components of the multi-piece roof panel 110 may be packaged and shipped for on-site assembly. In an example, each component of the multi-piece roof panel 110 may be shipped in the same shipping container.

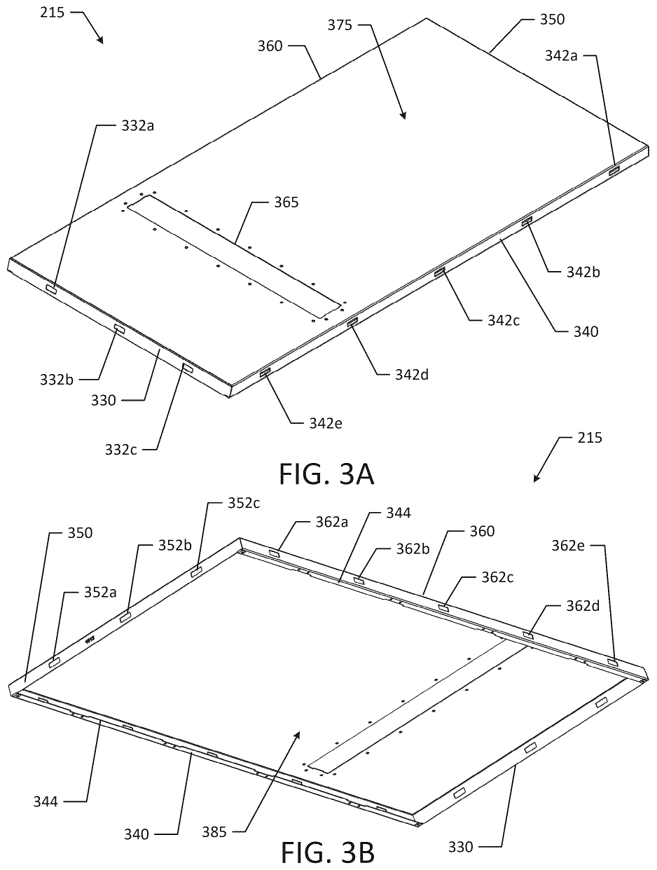

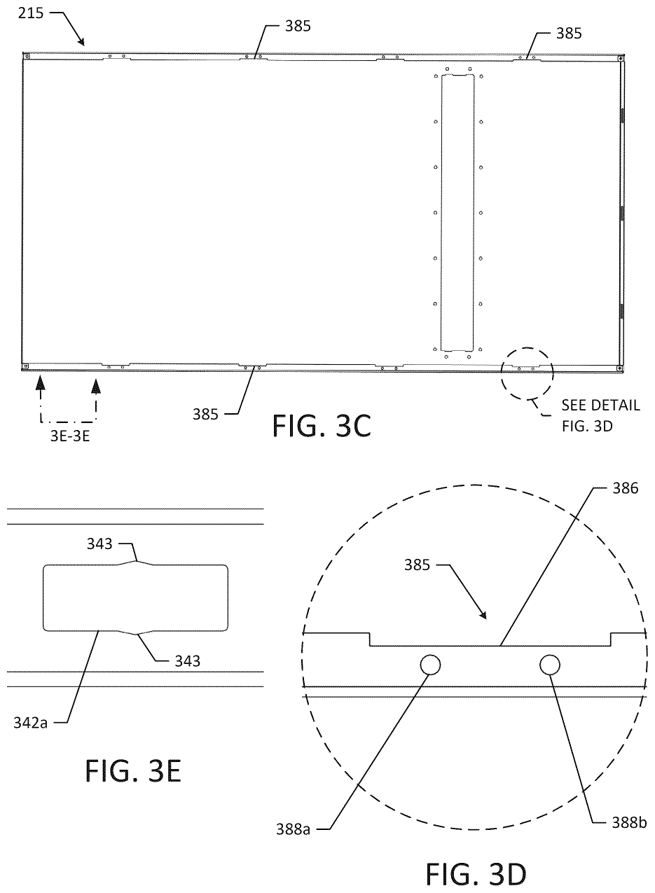

FIGS. 3A and 3B illustrate perspective views of central roof panel 215. In an example, the central roof panel 215 has a top surface 375, a bottom surface 385 and four side surfaces 330, 340, 350 and 360. Engagement surface 330 is the surface facing the truck tailgate near the distal end 204. In an example, the rear panel engagement surface 330 is configured to mate and engage with a corresponding engagement surface of the rear panel 130 (see FIG. 1). For example, rear panel engagement surface 330 may include one or more engagement interfaces 332 (e.g., engagement interfaces 332a-c) that are spaced along the rear panel engagement surface 330. The engagement interface 332 may be a rectangular shaped thru-hole that is adapted to receive mounting hardware for use in attaching the rear panel 130 to the central roof panel 215. For example, the rear panel 130 may have matching engagement interfaces or other engagement interfaces adapted for use with the mounting hardware to connect, attach, mate or otherwise couple the rear panel 130 to the central roof panel 215.

Similarly, front panel engagement surface 350 may include one or more engagement interfaces 352 (e.g., engagement interfaces 352a-c) that are spaced along the front panel engagement surface 350. The engagement interfaces 352 may be sized, shaped and configured similar to engagement surfaces 330 and may be configured to receive mounting hardware for use in attaching the front panel 150 to the central roof panel 215. For example, the front panel 150 may have matching engagement interfaces or other engagement interfaces adapted for use with the mounting hardware to connect, attach, mate or otherwise couple the front panel 150 to the central roof panel 215.

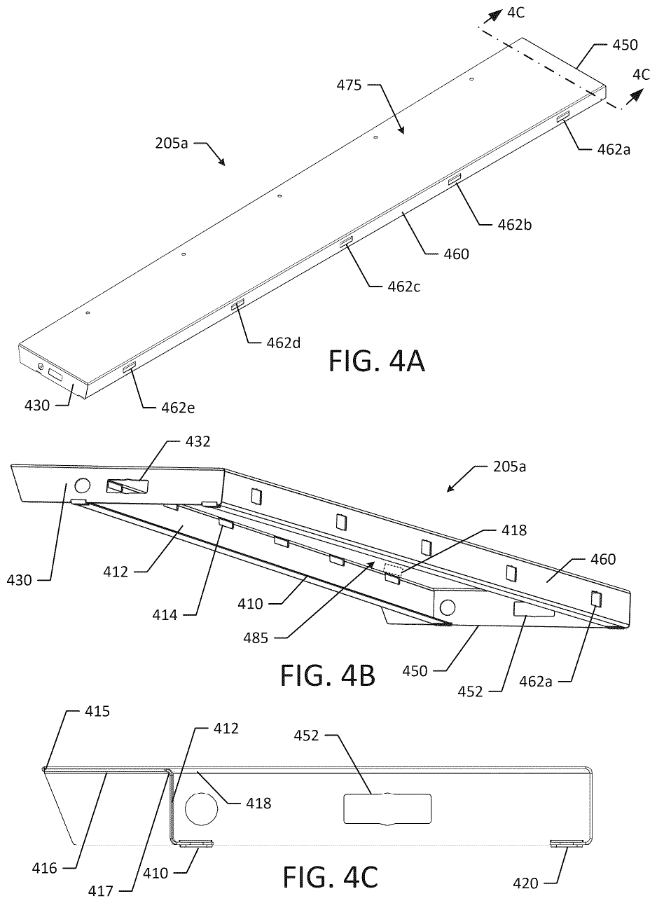

Engagement surfaces 340 and 360 may be configured to mate and engage with the respective extension panel from the pair of side extension panels 205. For example, left extension panel engagement surface 360 may be configured to engage with a corresponding engagement surface (e.g., central panel engagement surface 460 of left extension panel 205a of FIGS. 4A and 4B). The engagement surface 360 may include engagement interfaces 342 (e.g., engagement interfaces 342a-e), which may correspond to engagement interfaces on left extension panel 205a (see engagement interfaces 462a-e in FIG. 4A). Similarly, right extension panel engagement surface 340 may be configured to engage with a corresponding engagement surface on the right extension panel 205b. Engagement surface 340 includes engagement interfaces 342 (e.g., engagement interfaces 342a-e), similar to the other engagement interfaces described herein.

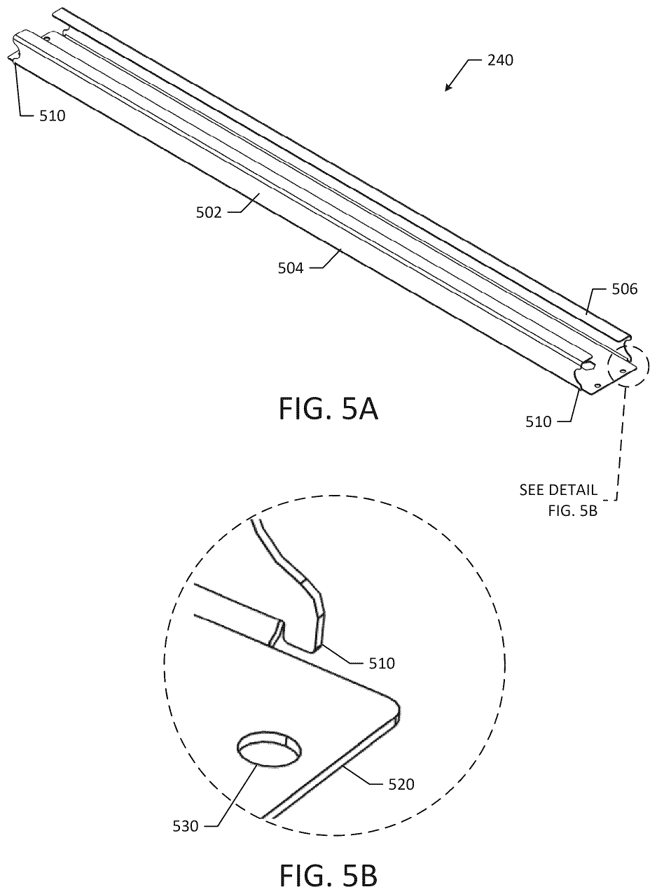

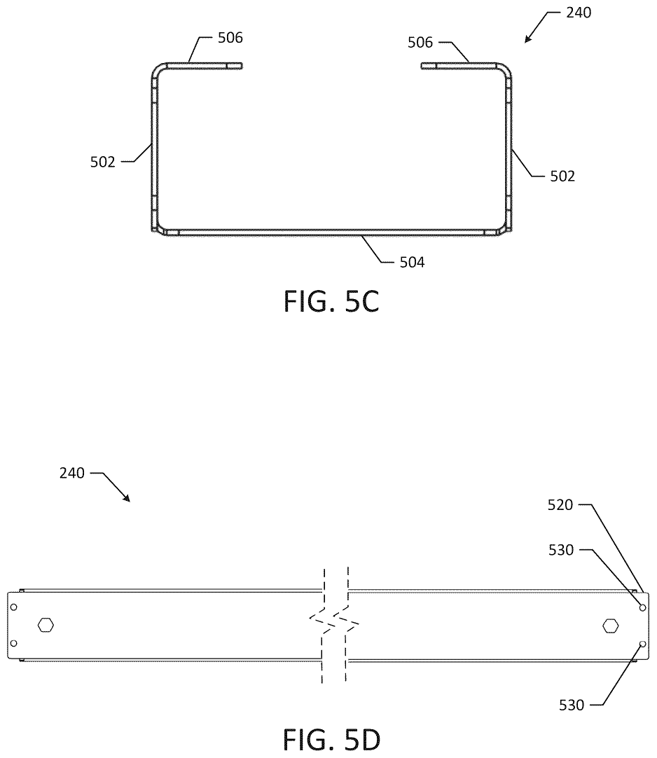

The central roof panel 215 may be made from metal, such as steel, aluminum or some other metal alloy, and may be cut, stamped and/or bent to form the central roof panel 215 illustrated in FIGS. 3A-3D. In other examples, the central roof panel 215 may be molded, formed or welded together. As noted above, the central roof panel 215 may be made from metal, such as steel. In an example, the metal may be grade 3CR12 steel, but it should be appreciated that other types of metals and/or steel may be used. In other examples, the central roof panel 215 may be made from resin(s), plastic(s), rubber(s), or any other material that provides adequate support and rigidity to serve as part of a roof panel for an automotive canopy. As illustrated in FIG. 3B, the left extension panel engagement surface 360 and the right extension panel engagement surface 340 include a shelf, lip or ledge that extends inward towards the center of the central roof panel 215 from the bottom side of engagement surfaces 340, 360. The shelf, lip or ledge, hereinafter referred to as a support brace shelf 344 is adapted to receive alignment, retention and mounting features of the support brace(s) 240, which is discussed in more detail with reference to FIG. 3D, FIG. 5A and FIG. 5B.

FIG. 3C is a bottom view of the central roof panel 215, which shows various attachment interfaces 385 that are positioned along the support brace shelves 344 on the left and right-side bottom edges of the central roof panel 215. The attachment interface is illustrated in the enlarged partial view illustrated in FIG. 3D, which shows the attachment interface 385 includes mounting holes 388a and 388b and notch 386. The notch 386 corresponds to and is adapted to receive alignment and retention protrusions (e.g., see retention protrusions 510 of FIGS. 5A and 5B). The alignment and retention protrusions are configured to sit within notch 386 such that the protrusions are adjacent to the ends of the notch 386.

FIG. 3E is an enlarged partial view of an example engagement interface (e.g., engagement interface 342a. The engagement interfaces are configured for use with mounting hardware, which may include a fastener, a fastener block and clamp, a lock washer, and a bolt (e.g., M6 bolt). When engagement interfaces of corresponding panels are aligned and attached to each other with the mounting hardware, the attachment may form a fixed and rigid connection between the two components or panels.

Moving now to FIGS. 4A, 4B, and 4C, which illustrate an example extension panel 205, and more specifically an example left extension panel 205a. FIG. 4A illustrates a perspective view of the left extension panel 205a. In an example, the extension panel(s) 205 (e.g., left extension panel 205a) have a top surface 475 and a bottom surface 485. Additionally, the extension panel(s) 205 include engagement interfaces along three of the four sides. For example, the left extension panel 205a may include an engagement interface 432 on a rear panel engagement surface 430, an engagement interface 452 on a front panel engagement surface 450, and a plurality of engagement interfaces 462 on a central roof panel engagement surface 460. Along the bottom side, at an interior edge (e.g., edge facing central roof panel 215), of engagement surface 460, a flat shelf 420 may extend inward creating an “L-shaped” wall that adds additional support and rigidity to the panel. The shelf 420 may be formed by folding or bending the material used to form engagement surface 460 to form the “L-shaped” wall where the arm of the “L-shape” extends away from the central roof panel 215 and towards rib 412, which is discussed in more detail below.

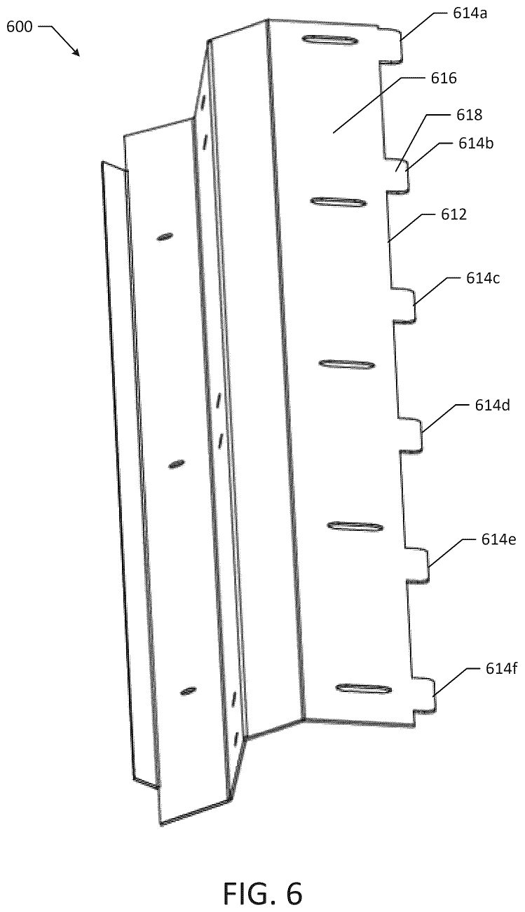

FIG. 4B illustrates another perspective view highlighting some of the underside of the left extension panel 205a, which may include a rib 412 that extends the length of the extension panel 205a. The rib 412 may be similar in structure to the engagement surface 460, which is shown in more detail in the cross-sectional view illustrated in FIG. 4C. In an example, the rib 412 increases strength and rigidity of the extension panel 205a. For example, the rib 412 may be an “L-shaped” rib 412 with a lower flat surface 410 that adds additional support and rigidity to the panel. Additionally, the rib 412 provides a surface for alignment and installation slots 414, which may be adapted to receive corresponding alignment and installation tabs on left-side panel 120. An example of the corresponding alignment and installation tabs (e.g., tabs 614) on a portion of a side panel (e.g., left-side panel 120 or right-side panel 140) are illustrated in FIG. 6 and described in more detail below.

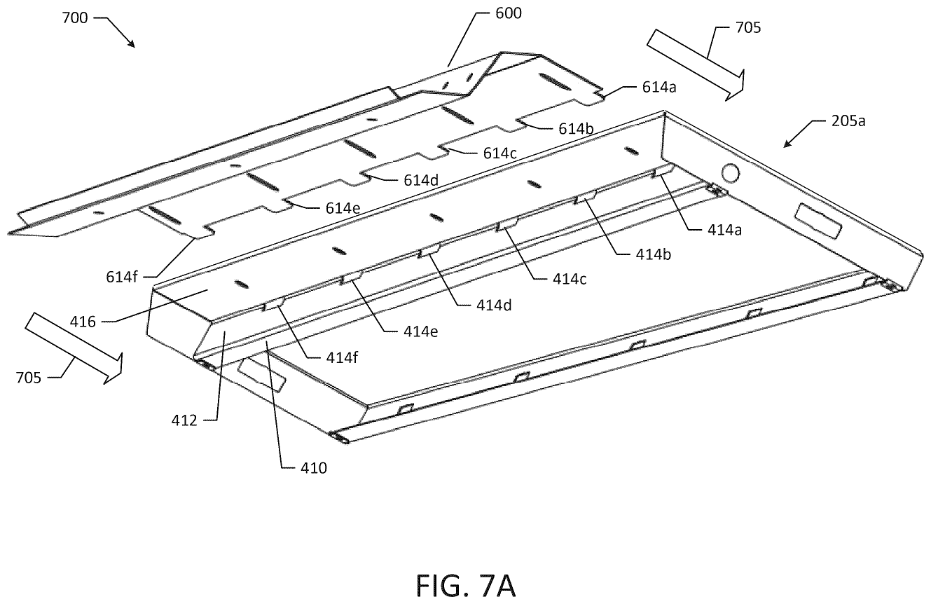

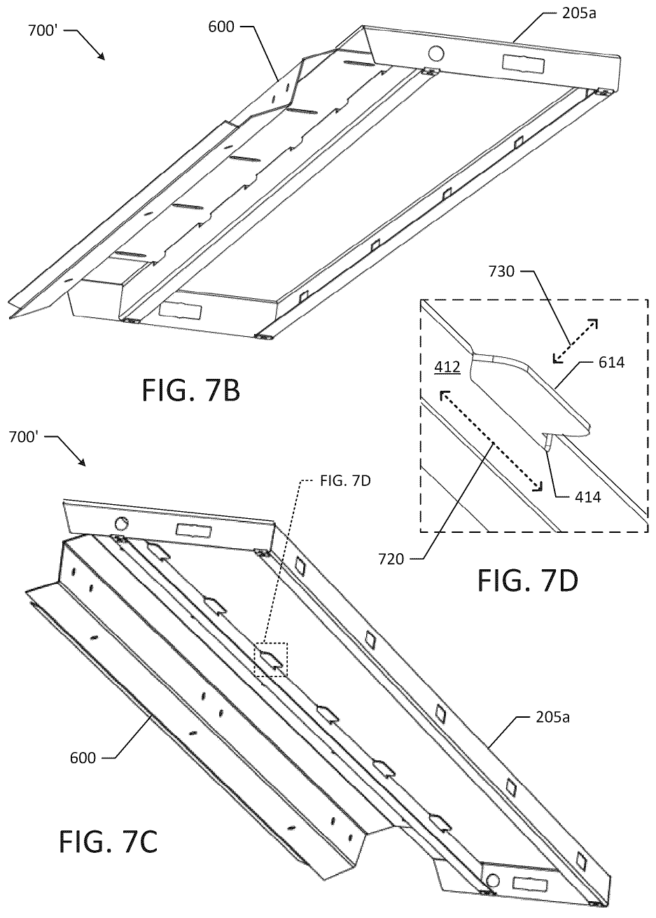

As illustrated in FIG. 4C, the rib 412 may be formed by folding over the material forming the top surface 475 at a bend point 415 that forms a double-layered section 416 before bending again at bend point 417 to form the rib 412. The double-layered section 416 advantageously provides extra rigidity and strength to the outside edge of the extension panel 205, which is a region that contacts and/or interfaces with a portion of a side panel (see top surface 616 of a portion 600 of the side panel of FIG. 6). The extra material, rigidity and strength reduces flexion at the outer edge of the extension panel 205 where the extension panel 205 joins with a respective side panel (e.g., left-side panel 120 or right-side panel 140). Also, portions(s) of the bottom surface 485 (e.g., portions 418, one of which is indicated by a dotted box in FIG. 4B) near alignment and installation slots 414 may contact and/or interface with corresponding alignment and installation tabs (e.g., tabs 614 of FIG. 6) to further reduce flexion caused by any bending or movement from a side panel and/or any forces imparted on the extension panel 205 from a respective side panel. Additional details about the interface between a side panel and an extension panel 205 are described in more detail with respect to FIGS. 6 and 7A-7D. The alignment slots 414 and tabs 614 are configured to maintain panel alignment during assembly.

As noted above, left extension panel engagement surface 360 of the central roof panel 215 is configured to engage with engagement surface 460 of the left extension panel 205a. The engagement interfaces on those surfaces (e.g., engagement interfaces 362 on surface 360 and engagement interfaces 462 on surface 460) may align and correspond to each other. For example, engagement interface 462a corresponds to engagement interface 362a, engagement interface 462b corresponds to engagement interface 362b, etc.

Similar to the central roof panel 215, the extension panels 205 (e.g., left extension panel 205a and right extension panel 205b) may be made from metal, such as steel aluminum or some other metal alloy and may be cut, stamped and/or bent. In other examples, the extension panels 205 may be molded, formed or welded together. In other examples, the extension panels 205 may be made from resin(s), plastic(s), rubber(s), or any other material that provides adequate support and rigidity to serve as part of a roof panel for an automotive canopy.

It should be appreciated that while FIGS. 4A-4C illustrate an example left extension panel 205a, an example right extension panel 205b may include all of the same features as extension panel 205a. For example, right extension panel 205b may be the same as left extension panel 205a, except with a mirrored orientation. Any of the description corresponding to the left extension panel 205a is applicable to right extension panel 205b, noting that orientational and directional differences.

Engagement surfaces 340 and 360 may be configured to mate and engage with the respective extension panel from the pair of side extension panels 205. For example, left extension panel engagement surface 360 may be configured to engage with a corresponding engagement surface (e.g., central panel engagement surface 460 of left extension panel 205a of FIGS. 4A and 4B). The engagement surface 360 may include engagement interfaces 342 (e.g., engagement interfaces 342a-e), which may correspond to engagement interfaces on left extension panel 205a (see engagement interfaces 462a-e in FIG. 4A). Similarly, right extension panel engagement surface 340 may be configured to engage with a corresponding engagement surface on the right extension panel 205b. (e.g., left extension panel 205a and right extension panel 205b). Engagement surface 340 includes engagement interfaces 342 (e.g., engagement interfaces 342a-e), similar to the other engagement interfaces described herein.

Turning now to FIGS. 5A-5D, which illustrate an example lateral support brace 240. FIG. 5A illustrates a perspective view of an example lateral support brace 240. The lateral support brace has side walls 502 joined by a bottom surface 504. The side walls 502 may include a shelf 506, thereby creating an “L-shaped” side wall that adds additional support and rigidity to the support brace 240 and the multi-piece roof panel 110 once assembled. The side walls 502, bottom surface 504 and shelves 506 are shown in more detail in FIG. 5C, which illustrates a front view of the lateral support brace 240.

FIG. 5B is an enlarged partial view of the lateral support brace 240, which shows one of the retention protrusions 510. The retention protrusions are at the ends of each side walls such that there are four retention protrusions 510 per support brace 240. A pair of retention protrusions 510 are adapted sit within the notch 386 on the central roof panel 215 (see FIG. 3D), which may assist with alignment during assembly. Once inserted within the notch, the protrusions 510 are adjacent to each end of the notch 386. The lateral support brace 240 may also include a mounting flange 520 on the bottom surface 504, which is illustrated in more detail in FIG. 5D, which shows a top view of the lateral support brace 240. The mounting flange 520 may include mounting holes 530, which correspond to mounting holes 388a and 388b on the central roof panel 25 (see FIG. 3D).

Referring back to FIG. 3E, which illustrates an enlarged partial view of an engagement interface (e.g., engagement interface 342a), each of the engagement interfaces described herein may have the same size, shape and characteristics of the engagement interface 342a. For example, the profile of the engagement interface 342a may match the profile of other engagement interfaces described herein (e.g., engagement interface 452 of FIG. 4C), such that when two components are aligned, the engagement interfaces align to form matching apertures on each component that acts as a symmetric cut-out that the mounting hardware is adapted for. The mounting hardware may include features that are oversized such that the mounting hardware provides compression or clamping forces to the components with the engagement interfaces. For example, the mounting hardware may have a lip, shelf, ledge or other feature that extends beyond the profile of the engagement interface such that portions of the mounting hardware press against and are unable to pass through the engagement interface. As noted above, the mounting hardware may include a fastener, a fastener block and clamp, a lock washer, and a bolt (e.g., M6 bolt). The fastener block and/or clamp may be sized and shaped such that a portion of the fastener block and/or clamp fits through the engagement interface and another portion extends beyond the engagement interface. As illustrated in FIG. 3E, the engagement interface 342a may include one or more circular notches 343, which may assist with alignment and installation of a corresponding fastening block that is configured to fasten one or more components or panels together. Similarly engagement surface 452 of FIG. 4C may also include circular notches.

Referring back to FIGS. 2A, 3B, 3C, 4B, 4C, 5A, 5C many of the components include rolled edges that form a shelf, lip or ledge or the like to add rigidity and strength to the components. By including additional structural features, such as rolled edges, each component of the multi-piece roof panel 110 is advantageously light weight while maintaining advantageous mechanical properties to resist bending, twisting or buckling under the forces and loads experienced during driving, travel and use of the vehicle. By providing a light-weight multi-piece roof panel that is provides sufficient rigidity and strength, the truck bed may be protected from the elements without adding excessive weight to the vehicle, thereby providing improved fuel efficiency compared to heavier vehicle canopies.

Turning now to FIG. 6 and FIGS. 7A-7D, an example mounting portion 600 of a side panel (e.g., mounting portion of left-side panel 120) with alignment and installation tabs 614 is illustrated. The mounting portion 600 of the side panel may include a top surface 616 and several alignment and installation tabs 614 (e.g., tabs 614a-f) aligned along and protruding from its outer edge, which is referred to herein as a rib-interfacing edge 612. The alignment and installation tabs 614 are configured to extend through and be received by the alignment and installation slots 414 (see FIG. 4B). The top portion 618 of each alignment tab 614 may contact and/or interface with corresponding portions 418 of the bottom surface of the extension panel 205. As noted above, the interaction of these surfaces may advantageously strengthen and stiffen the overall assembly of the automotive canopy 100 by reducing flexion between the components.

For example, if the side panel (e.g., left-side panel 120) flexes and bends outward (e.g., counter-clockwise looking forward towards the front of the vehicle from the rear of the left-side panel 205a), the top portion 618 of the alignment and installation tab 614 may press into the corresponding portion 418 of the bottom surface of the extension panel to restrict and prevent further movement, twisting and/or flexion. Similarly, if the side panel 120 flexes and bends inward (e.g., clockwise when looking forward towards to the front of the vehicle), the top surface 616 of the mounting portion may press into the double-layered section 416 of the extension panel 205 thereby restricting and preventing further movement, twisting and/or flexion of the side panel 120. Furthermore, since the rib 412 and double-layered section 416 extend along the entire length or nearly the entire length of the extension panel 205 and the tabs 614 interact with alignment and installation slots 414 spaced along the entire length or nearly the entire length of the extension panel 205, any forces or stresses applied to the corresponding panels are advantageously distributed through and/or over larger areas. By evenly distributing forces or stresses over or through an entire panel or large portions of a panel, the panel(s) are advantageously resistant to bending, buckling or other damage that may be caused by movement or flexion during use.

FIG. 7A shows an exploded perspective view of a side assembly 700. The exploded view shows a mounting portion 600 of a side panel (e.g., left-side panel 120) aligned with an extension panel (e.g., left extension panel 205a) prior to assembly. It should be appreciated that the illustrated mounting portion 600 of a side panel, rather than a full side panel, is illustrated for ease of understanding and to more clearly show the mating components. During assembly, the left-side panel 120 is advanced towards the left extension panel 205 in the direction of arrow(s) 705 until the alignment and installation tabs 614 extend through installation and alignment slots 414, as shown in FIGS. 7B and 7C. FIGS. 7B and 7C show a perspective view of the side assembly 700′ after the mounting portion 600 of the left-side panel 120 is advanced forward and fully inserted into the left extension panel 205.

FIG. 7D is an enlarged partial view showing the interface between an installation and alignment slot 414 and a corresponding installation and alignment tab 614 of a side panel (e.g., left-side panel 120). As shown in FIG. 7D, the installation and alignment slot(s) 414 are sized and shaped to receive tabs 614. The width of the slot(s) 414 is slightly wider than tab(s) 614 to allow tabs 614 to pass through. In an example, the width of the slot(s) 414 is similar to the width of the tab(s) 614 to minimize and restrict side-to-side movement in the direction of arrow 720. For example, the small gaps between the edge of a tab 614 and the edge of a slot 414 may allow for slight side-to-side movement in the direction of arrow 720 before the two edges come into physical contact with each other, which prevents further side-to-side movement. Additionally, the installation and alignment slot(s) 414 allow the tabs 614 to extend through in the direction of arrow 730 until the rib-interfacing edge 612 of the mounting portion 600 contacts rib 412 of the extension panel 205.

Although the multi-piece roof panel 110 has been described in certain specific aspects, many additional modifications and variations would be apparent to those skilled in the art. In particular, any of the various processes described above can be performed in alternative sequences and/or in parallel in order to achieve similar results in a manner that is more appropriate to the requirements of a specific application. It is therefore to be understood that the present disclosure can be practiced otherwise than specifically described without departing from the scope and spirit of the present embodiments. Thus, embodiments of the present invention should be considered in all respects as illustrative and not restrictive. It will be evident to the annotator skilled in the art to freely combine several or all of the embodiments discussed here as deemed suitable for a specific application of the invention. Throughout this disclosure, terms like “advantageous”, “exemplary” or “preferred” indicate elements or dimensions which are particularly suitable (but not essential) to the invention or an embodiment thereof, and may be modified wherever deemed suitable by the skilled annotator, except where expressly required. Accordingly, the scope of the invention should be determined not by the embodiments illustrated, but by the appended claims and their equivalents.

1. A multi-piece roof for an automotive canopy, comprising:
a left extension panel having a proximal end with a first width and a distal end with a second width;
a right extension panel having a proximal end with a third width and a distal end with a fourth width; and
a central roof panel having a top side, a bottom side, a left side, a right side, a front side and a back side, wherein the left side is configured to couple with the left extension panel and the right side is configured to couple with the right extension panel and the right extension panel.

2. The multi-piece roof of claim 1, wherein the left extension panel, the right extension panel, and the central roof panel are sized and shaped to fit within a single shipping container.

3. The multi-piece roof of claim 1, wherein the left extension panel is configured to connect to a left-side panel, a front panel, and a rear panel of the automotive canopy.

4. The multi-piece roof of claim 3, wherein the right extension panel is configured to connect to a right-side panel, the front panel, and the rear panel of the automotive canopy.

5. The multi-piece roof of claim 4, wherein the central roof panel is configured to connect to the front panel and the rear panel of the automotive canopy.

6. The multi-piece roof of claim 5, wherein the left extension panel, the right extension panel, the central roof panel, the left-side panel, the right-side panel, the front panel, and the rear panel are sized and shaped to fit within a single shipping container.

7. The multi-piece roof of claim 6, wherein the shipping container is made at least partially from cardboard.

8. The multi-piece roof of claim 7, wherein the shipping container is a corrugated cardboard box.

9. The multi-piece roof of claim 1, wherein the left extension panel, the right extension panel, and the central roof panel are configured to attach to and fit onto a first model type of pickup truck.

10. The multi-piece roof of claim 9, wherein the central roof panel and a set of different extension panels are configured to attach to and fit onto a second model type of pickup truck, the second model type of pickup truck being different from the first type of pickup truck and having different truck bed dimensions that the first model type of pickup truck.

11. The multi-piece roof of claim 1, wherein the first width and the second width of the left extension panel depend on a model type of pickup truck that the vehicle canopy is adapted for.

12. The multi-piece roof of claim 1, wherein the central roof panel has a length and width, the length of the central roof panel is a first length and the width is a first width for a first model type of vehicle.

13. The multi-piece roof of claim 12, wherein the length is a second length and the width is the first width for a second model type of vehicle, the second model type being different than the first model type.

14. The multi-piece roof of claim 1, further comprising a removable vent insert, and wherein the central roof panel includes a vent aperture adapted to receive the removable vent insert.

15. The multi-piece roof of claim 14, further comprising a plurality of support braces that are sized and shaped to span across the central roof panel, wherein the vent aperture is spaced between two of the plurality of support braces.

16. The multi-piece roof of claim 15, wherein the plurality of support braces are formed by stamping and folding metallic material.

17. A modular kit for assembly of a multi-piece roof for an automotive canopy, the modular kit comprising:
a left extension panel;
a right extension panel;
a central roof panel having a left side, a right side, a top side and a bottom side, wherein the left side is configured to couple with the left extension panel and the right side is configured to couple with the right extension panel; and
a plurality of support braces configured to couple to the bottom side of the central roof panel.

18. The modular kit of claim 17, further comprising an air vent located on the central roof panel.

19. An automotive canopy comprising:
a front panel;
a plurality of side panels;
a rear panel; and
a multi-piece roof, comprising:
a left extension panel,
a right extension panel,
a central roof panel having a left side, a right side, a top side and a bottom side, wherein the left side is configured to couple with the left extension panel and the right side is configured to couple with the right extension panel, and
a plurality of support braces configured to couple to the bottom side of the central roof panel.
